(19) United States
(12) Patent Application Publication
(10) Pub. No.: US 2026/0124838 A1
(43) Pub. Date: May 7, 2026

(54) LIQUID DISCHARGE HEAD AND LIQUID DISCHARGE APPARATUS

(71) Applicant: CANON KABUSHIKI KAISHA, Tokyo (JP)

(72) Inventor: TAKEHO MIYASHITA, Kanagawa (JP)

(21) Appl. No.: 19/367,441

(22) Filed: Oct. 23, 2025

(30) Foreign Application Priority Data
Nov. 5, 2024 (JP) 2024-193514

(51) Int. Cl. B41J 2/175; B41J 2/18; B41J 2/19; B41J 2/20

(52) U.S. Cl. CPC B41J 2/17596; B41J 2/18; B41J 2/19; B41J 2/20; B41P 2251/11

(57) ABSTRACT

A liquid discharge head includes a discharge unit for discharging liquid, an upstream flow path for supplying liquid to the discharge unit, a downstream flow path for collecting liquid from the discharge unit, and a diaphragm pump for sending liquid in the downstream flow path to the upstream flow path not via the discharge unit. The diaphragm pump includes a pump chamber for functioning as a pump, a suction hole for suctioning the liquid in the downstream flow path into the pump chamber, and a discharge hole for discharging the liquid in the pump chamber to the upstream flow path. The pump chamber is formed with an air bubble discharge hole different from the suction hole and the discharge hole. Air bubbles in the pump chamber are discharged outside through the air bubble discharge hole by reducing a pressure in the air bubble discharge hole.

### BACKGROUND

### Field of the Technology

The present disclosure relates to a liquid discharge head and a liquid discharge apparatus.

### Description of the Related Art

A liquid discharge apparatus includes a liquid discharge head for discharging liquid to achieve a desired purpose thereby. For example, an inkjet recording apparatus is mounted with an inkjet head serving as a liquid discharge head on a carriage to record images, characters, and the like on a recording medium, by discharging ink from a discharge unit included in the ink jet head. Since discharge ports provided in a discharge element substrate for discharging ink contact the ambient air, there is a risk that the ink may evaporate to be thickened and solidified, depending on a type of the liquid (ink). To suppress this risk, there is known a configuration for providing in the liquid discharge head a supply path for supplying liquid to the discharge element substrate, and a collection path for collecting liquid from the discharge element substrate, and circulating the liquid with a circulation pump. By circulating the liquid, since the thickened liquid spreads, it is possible to reduce the risk of the local solidification of the ink.

Further, there is also known a configuration in which a diaphragm pump is provided in a liquid discharge head as a circulation pump to effectively circulate liquid in a small circulation route. In general, the diaphragm pump includes an actuator for converting an input energy into a physical energy, a diaphragm deforming along with the deformation of the actuator, and a pump chamber deforming along with the deformation of the diaphragm. In the diaphragm pump, the inner volume of the pump chamber repeatedly expands and contracts along with the deformation of the diaphragm. At this time, since the pressure in the pump chamber increases or decreases, the fluid is repeatedly suctioned from outside the pump into the pump chamber, and discharged outside the pump. Further, in the diaphragm pump, a unidirectional flow of the fluid is created by providing check valves in a suction port for suctioning the fluid into the pump chamber therethrough, and in a discharge port for discharging the fluid from the pump chamber therethrough.

By repeatedly operating the diaphragm in this state, the diaphragm pump can suction and discharge the fluid as a pump. Since the diaphragm pump suctions and discharges the fluid by causing the pressure variation by changing the inner volume of the pump chamber, when air bubbles contained in the liquid enter the pump chamber, the liquid sending efficiency may deteriorate because the pressure variation becomes small due to the repeated expansions and contractions of the air bubbles.

Japanese Patent Laid-open No. 2018-30350 describes a liquid discharge head having a diaphragm pump mounted thereon as a diaphragm pump for circulating liquid. In Japanese Patent Laid-open No. 2018-30350, a pump chamber is largely deformed to cause a high-pressure variation to discharge air bubbles having entered the pump chamber, by driving an actuator of the diaphragm pump with a relatively high voltage (e.g., 120 V(volts) to 300 V).

However, in a case where the actuator is driven by the relatively high voltage to discharge air bubbles having entered the pump chamber as described in Japanese Patent Laid-open No. 2018-30350, it may influence users. To prevent the influence, an additional configuration, for example, an interlock mechanism may be used, and there is a concern of complicating the apparatus.

### SUMMARY

In consideration of the above issues, the present disclosure is directed to a liquid discharge head capable of discharging air bubbles having entered a pump chamber, without complicating the apparatus and driving a diaphragm pump with a high voltage, and a liquid discharge apparatus employing the liquid discharge head.

According to some embodiments of the present disclosure, a liquid discharge head includes a discharge unit configured to discharge liquid, an upstream flow path configured to supply liquid to the discharge unit, a downstream flow path configured to collect liquid from the discharge unit, and a diaphragm pump configured to send liquid in the downstream flow path to the upstream flow path not via the discharge unit. The diaphragm pump includes a pump chamber configured to function as a pump, a suction hole configured to suction the liquid in the downstream flow path into the pump chamber, and a discharge hole configured to discharge the liquid in the pump chamber to the upstream flow path. The pump chamber is formed with an air bubble discharge hole different from the suction hole and the discharge hole. Air bubbles in the pump chamber are discharged through the air bubble discharge hole by reducing a pressure in the air bubble discharge hole.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram schematically illustrating a configuration of a liquid discharge apparatus. FIG. 1B is a block diagram illustrating a control system of the liquid discharge apparatus.

FIG. 2 is an exploded perspective diagram illustrating a liquid discharge head.

FIG. 3 is a diagram schematically illustrating an external appearance of a circulation unit.

FIG. 4 is a cross-section diagram schematically illustrating an ink circulation route of the liquid discharge head.

FIG. 5 is a block diagram illustrating the ink circulation route.

FIG. 6 is a diagram schematically illustrating a driving mechanism of a diaphragm pump.

FIG. 7A is a perspective diagram illustrating an external appearance of a front side of the diaphragm pump. FIG. 7B is a perspective diagram illustrating an external appearance of a back side of the diaphragm pump.

FIG. 8 is a cross-section diagram illustrating the diaphragm pump.

FIG. 9 is a schematic diagram illustrating an air flow when air bubbles are discharged.

FIG. 10 is a block diagram illustrating an ink circulation route.

FIG. 11 is a cross-section diagram illustrating a diaphragm pump.

### DESCRIPTION OF THE EMBODIMENTS

Hereinbelow, various exemplary embodiments, features, and aspects of the present disclosure will be described with reference to the attached drawings. Note that the embodiments described below are not intended to limit the range of the present disclosure, and not all the combinations of the features described in the embodiments are necessarily essential for the solution of the present disclosure. In addition, the same reference numbers are assigned to the same components.

### First Embodiment

A liquid discharge head according to a first embodiment is an ink jet head for discharging ink, and a liquid discharge apparatus is an ink jet recording apparatus, but they are not limited to the ink jet head and the ink jet recording apparatus, as long as they discharge liquid.

### <Liquid Discharge Apparatus>

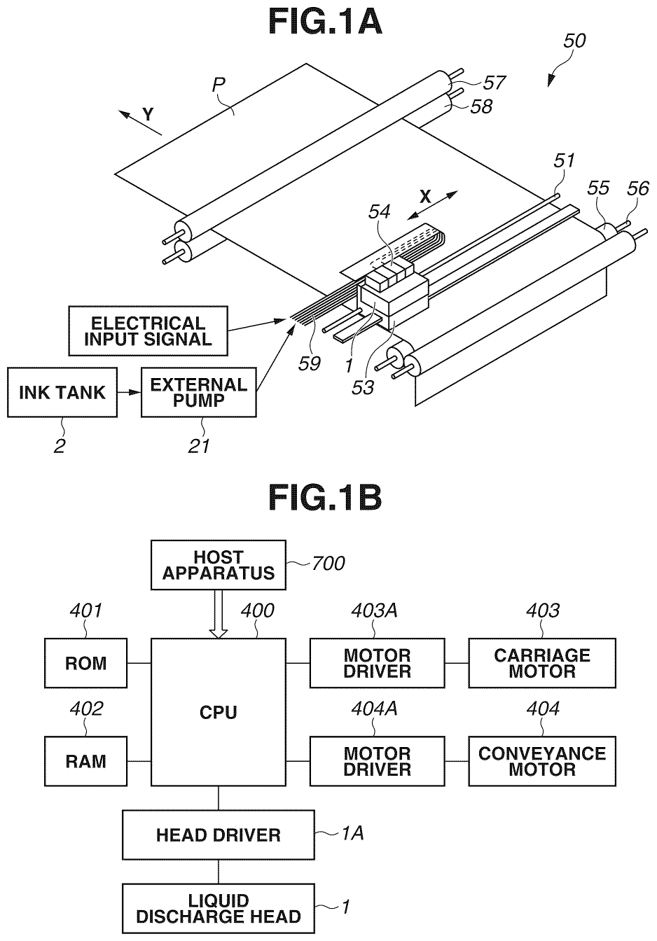

FIG. 1A is a perspective diagram schematically illustrating a configuration example of a liquid discharge apparatus employing a liquid discharge head 1.

The liquid discharge apparatus according to the present embodiment is a serial scan type liquid discharge apparatus 50. The liquid discharge head 1 serving as an ink jet head is mounted on a carriage 53, which moves in a main scanning direction (arrow X direction) along a guide shaft 51. A recording medium P is conveyed in a sub-scanning direction (arrow Y direction) intersecting with (orthogonal to in this example) the main scanning direction by conveyance rollers 55, 56, 57, and 58.

In the present embodiment, the liquid discharge head 1 so-called serial type of liquid discharge head, which discharges ink while moving in the main scanning direction, is described as an example, but it is not limited thereto. More specifically, a liquid discharge head can also be employed, which is so-called full line type liquid discharge head formed with discharge ports along the full width direction area of the recording medium P, and capable of discharging ink in the full width direction area of the recording medium P without moving in the main scanning direction.

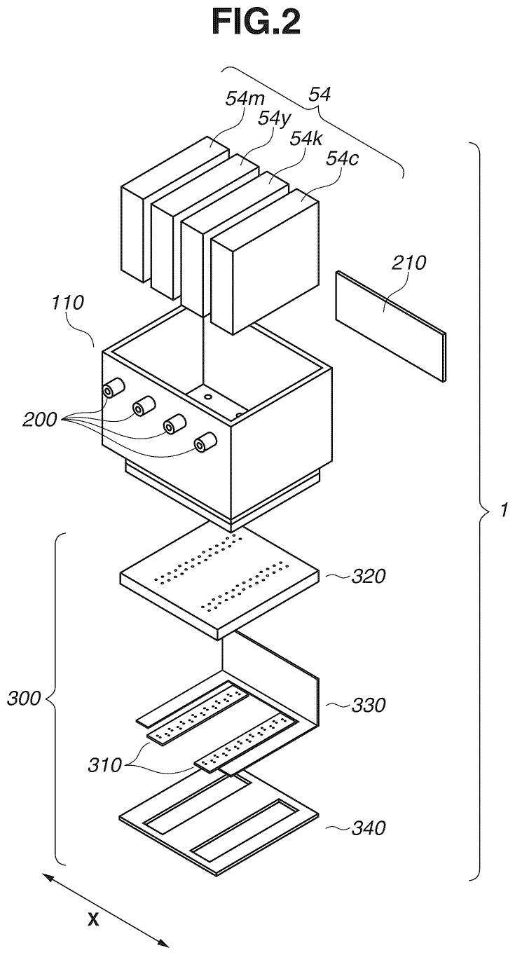

The liquid discharge head 1 includes ink circulation units 54 and a discharge unit 300 (see FIG. 2). The discharge unit 300 is provided with a plurality of discharge ports, energy generation elements (hereinbelow, referred to as discharge elements) for generating discharge energies for discharging liquid from the respective discharge ports. The specific configuration thereof will be described below. The discharge energy generation elements included in the discharge unit 300 are driven by a head driver 1A illustrated in FIG. 1B in response to an electrical input signal from an electrical connection substrate. Electrical wiring lines used for discharging ink, and pipes for ink and air are connected to the carriage 53 through ink supply tubes 59.

The liquid discharge apparatus 50 is also provided with an ink tank 2 serving as an ink supply source, and an external pump 21. The ink stored in the ink tank 2 is supplied to each of the ink circulation units 54 via the ink supply tubes 59 by a driving force of the external pump 21.

The liquid discharge apparatus 50 forms an image on the recording medium P by repeatedly performing a record scanning for recording with the liquid discharge head 1 mounted on the carriage 53 discharging ink while moving in the main scanning direction, and a conveyance operation conveying the recording medium P in the sub-scanning direction. The liquid discharge head 1 according to the present embodiment can discharge four types of inks, i.e., black (B), cyan (C), magenta (M), and yellow (Y), and can record a full color image using these inks. However, the inks dischargeable from the liquid discharge head 1 are not limited to the four types of inks described above. The present disclosure is also applicable to a liquid discharge head for discharging other types of inks. In other words, the types and the number of inks discharged from the liquid discharge head 1 are not limited.

A cap member (not illustrated) is also arranged at a position outside the conveyance path of the recording medium P, and when the recording operation is not performed, the cap member relatively moves to a position at which the face surface of the liquid discharge head 1 is covered, and performs suction operations for preventing the discharge ports from drying, and for ink filling and recovery.

FIG. 1B is a block diagram illustrating a control system of the liquid discharge apparatus 50. A central processing unit (CPU) 400 functions as a control unit for controlling each unit of the liquid discharge apparatus 50 based on a program for, for example, a processing procedure stored in a read only memory (ROM) 401. A random-access memory (RAM) 402 is used as a work area used by the CPU 400 for executing these operations. The CPU 400 receives image data from a host apparatus 700 located outside the liquid discharge apparatus 50, and controls the head driver 1A to control the driving of the discharge elements provided in the discharge unit 300. The CPU 400 also controls a carriage motor 403 for moving the carriage 53 via a motor driver 403A, and controls a conveyance motor 404 for conveying the recording medium P via a motor driver 404A.

### <Basic Configuration of Liquid Discharge Head>

FIG. 2 is an exploded perspective diagram illustrating the liquid discharge head 1 according to the present embodiment. As illustrated in FIG. 2, the liquid discharge head 1 includes the ink circulation units 54. The ink circulation units 54 include ink circulation units 54m, 54y, 54k, and 54c corresponding to the respective types of inks. The respective ink circulation units 54 are connected to a flow path member 110. The ink circulation units 54 and the flow path member 110 can be connected by a screw fastening method with a sealing member sandwiched therebetween, or can be connected by welding. The flow path member 110 includes joints 200 for receiving ink from the main body of the liquid discharge apparatus 50. The joints 200 are respectively connected with the ink circulation units from 54m to 54c so as to communicate therewith. When the liquid discharge head 1 is mounted on the liquid discharge apparatus 50, supply tubes (not illustrated) respectively corresponding to the inks are connected to the joints 200 from the main body side of the liquid discharge apparatus 50. The inks supplied from the supply tubes are supplied to the ink circulation units from 54m to 54c via the joints 200 of the flow path member 110, respectively. The discharge unit 300 is connected to the bottom surface of the flow path member 110, and the ink supplied to each of the ink circulation units 54 is supplied to the discharge unit 300 via the flow path member 110.

The discharge unit 300 includes discharge elements 310 each provided with an actuator for discharging ink, a support member 320, an electric wiring substrate 330 for transmitting electrical signals to each discharge element, and a cover member 340 for covering the electric wiring substrate 330. The discharge elements 310 and the electric wiring substrate 330 are fixedly bonded to the support member 320, and the cover member 340 is also bonded and joined to cover the surface of the electric wiring substrate 330. The discharge elements 310 and the electric wiring substrate 330 are electrically connected by wire bonding, but the electrical connection method is not limited thereto, and a flying lead bonding or the like can also be used. In the cover member 340, the portions corresponding to the discharge elements 310 are openings. The discharge unit 300 and the flow path member 110 can be connected with an adhesive material, or can be fixed by screw fastening with the sealing member sandwiched therebetween.

Each of the discharge elements 310 can be a thermoelectric conversion element that converts a supplied electrical energy to a thermal energy to generate a pressure for discharging liquid, or can be a piezoelectric element that converts a supplied electrical energy to a mechanical energy to generate a pressure for discharging liquid.

As long as the element can generate the energy for discharging liquid, there is no specific limitation thereto.

The surface of the flow path member 110 opposite to the joints 200 is a contact surface to which a head electric substrate 210 for receiving electrical signals from the liquid discharge apparatus 50 is connected. The electrical signals are transmitted to the discharge elements 310 from the head electric substrate 210 via the electric wiring substrate 330 of the discharge unit 300. At this time, the head electric substrate 210 and the flow path member 110 can also be connected and fixed by swaging, bonding, or a two-sided adhesive tape. The head electric substrate 210 and the electric wiring substrate 330 are electrically connected by anisotropically conductive film (ACF) pressure bonding, but it is not limited thereto. Wire bonding or flying lead bonding can also be used.

### <Circulation Unit>

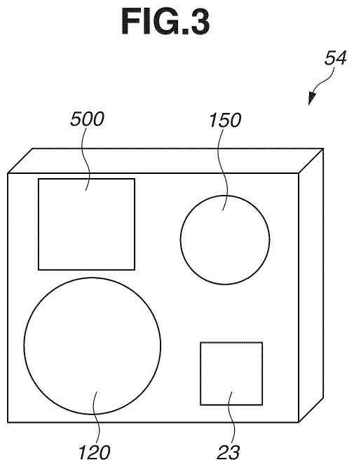

FIG. 3 is a schematic diagram illustrating an external appearance of one of the ink circulation units 54m, 54y, 54k, and 54c (hereinbelow, referred to as an ink circulation unit 54) corresponding to a type of ink applied to the liquid discharge apparatus 50 according to the present embodiment. The ink circulation unit 54 includes a diaphragm pump 500. Other than the diaphragm pump 500, the ink circulation unit 54 can include a filter 23, a first pressure adjustment unit 120, and a second pressure adjustment unit 150.

### <Circulation Route in Liquid Discharge Head>

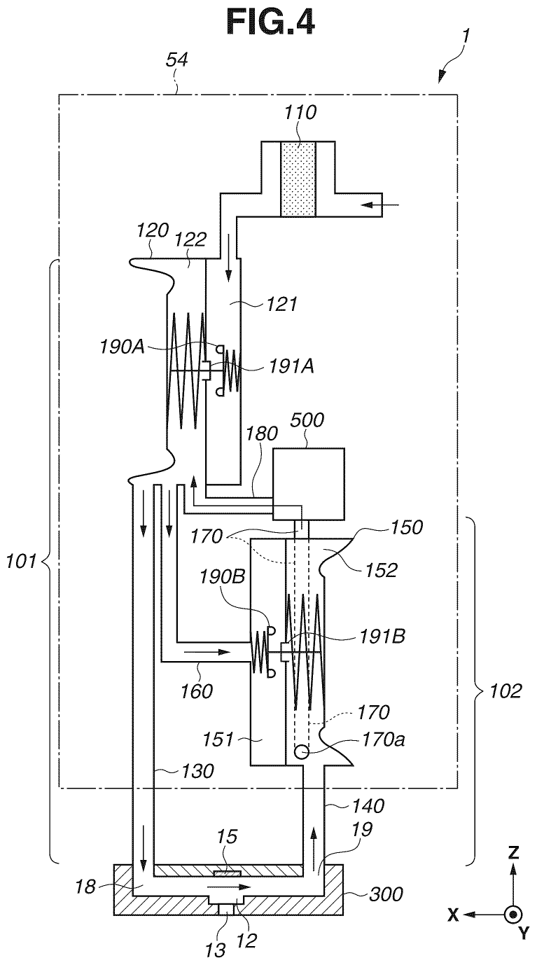

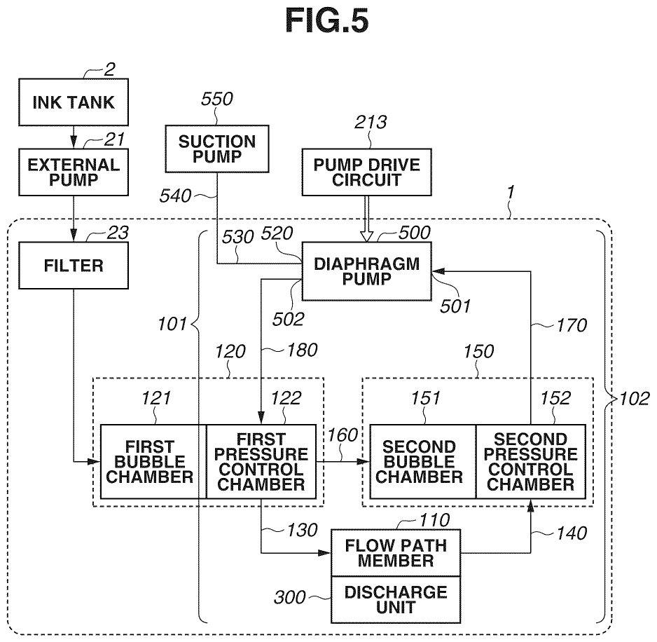

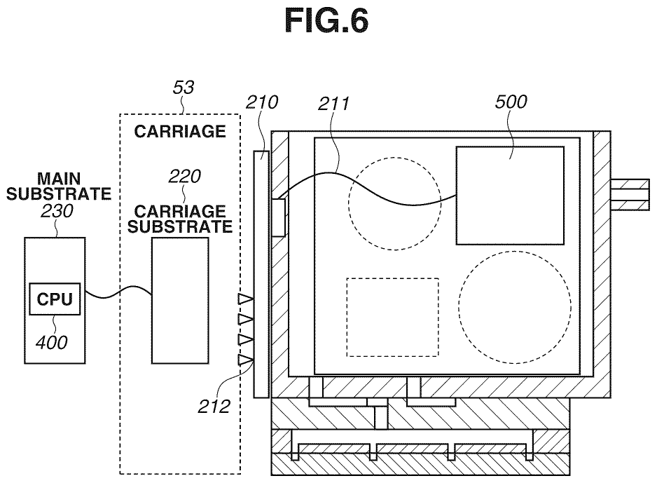

FIG. 4 is a longitudinal cross-section diagram schematically illustrating a circulation route of a type of ink (a color of ink) configured in the liquid discharge head 1. In addition, in order to describe the circulation route more clearly, the relative positions of the components (e.g., first pressure adjustment unit 120, second pressure adjustment unit 150, and diaphragm pump 500) in FIG. 5 are simplified. Thus, the relative positions of the components are different from the relative positions of the components illustrated in FIG. 6. FIG. 5 is a block diagram schematically illustrating the circulation route illustrated in FIG. 4. As illustrated in FIGS. 4 and 5, the first pressure adjustment unit 120 includes a first bubble chamber 121 and a first pressure control chamber 122. The first pressure control chamber 122 adjusts the pressure in a supply flow path 130 located between the first pressure control chamber 122 in an upstream flow path 101 and the discharge unit 300. The second pressure adjustment unit 150 includes a second bubble chamber 151 and a second pressure control chamber 152. The first pressure adjustment unit 120 is configured so as to become relatively higher in control pressure than the second pressure adjustment unit 150. In the present embodiment, using the first and the second pressure adjustment units 120 and 150, the circulation within a predetermined pressure range is achieved in the circulation route. The present embodiment is also configured such that the ink flows in a pressure chamber 12 at a flow rate corresponding to the pressure difference between the first pressure adjustment unit 120 and the second pressure adjustment unit 150. Hereinbelow, the circulation route in the liquid discharge head 1 and the flow of the ink in the circulation route will be described with reference to FIGS. 4 and 5. Note that, each arrow in FIGS. 4 and 5 indicates a direction in which the ink flows.

First, the connection state of the components in the liquid discharge head 1 will be described. The external pump 21 for delivering to the liquid discharge head 1 ink stored in an ink tank 2 (see FIG. 5) provided outside the liquid discharge head 1 is connected with the ink circulation unit 54 via the ink supply tube 59 (see FIG. 1). The filter 23 is provided in an ink flow path (discharge flow path) located on the upstream side of the ink circulation unit 54. An ink supply path (discharge flow path) located on the downstream side of the filter 23 is connected to the first bubble chamber 121 in the first pressure adjustment unit 120. The first bubble chamber 121 communicates with the first pressure control chamber 122 via a communication port 191A that is openable/closable by a valve 190A illustrated in FIG. 5. Note that the discharge flow path is a flow path for discharging the liquid in the ink tank 2 provided outside the liquid discharge head 1 to the liquid discharge head 1 for supplying the ink to the pressure chamber 12.

The first pressure control chamber 122 is connected to the supply flow path 130, a bypass flow path 160, and a pump outlet port flow path 180 of the diaphragm pump 500. The supply flow path 130 passes through the flow path member 110, and is connected to a common supply path 18 via an ink supply port provided in the discharge unit 300. The bypass flow path 160 is also connected to the second bubble chamber 151 provided in the second pressure adjustment unit 150. The second bubble chamber 151 communicates with the second pressure control chamber 152 via a communication port 191B opened and closed by a valve 190B illustrated in FIG. 4. In addition, FIGS. 4 and 5 illustrate an example in which one end of the bypass flow path 160 is connected to the first pressure control chamber 122 in the first pressure adjustment unit 120, and the other end of the bypass flow path 160 is connected to the second bubble chamber 151 in the second pressure adjustment unit 150. However, the one end of the bypass flow path 160 can also be connected to the supply flow path 130, and the other end of the bypass flow path 160 can be connected to the second bubble chamber 151.

The second pressure control chamber 152 is connected to a collection path 140. The collection path 140 is connected to a common collection path 19 via the flow path member 110 and an ink collection port provided in the discharge unit 300. The second pressure control chamber 152 is also connected to the diaphragm pump 500 via a pump inlet port flow path 170.

Next, a flow of ink in the liquid discharge head 1 having the above-described configuration will be described. After air bubbles and foreign matters such as dust are removed from the ink by passing through the filter 23, the ink supplied to the ink circulation unit 54 is discharged to the first bubble chamber 121 provided in the first pressure adjustment unit 120. The pressure of the ink reduces due to the pressure loss caused when the ink passes through the filter 23, but the pressure of the ink at this stage is in a positive pressure state. Thereafter, when the valve 190A is in an open state, the ink discharged to the first bubble chamber 121 passes through the communication port 191A, and is discharged to the first pressure control chamber 122. The pressure of the ink discharged to the first pressure control chamber 122 changes from the positive pressure to the negative pressure due to the pressure loss caused when the ink passes through the communication port 191A. Next, a flow of the ink in the circulation route will be described. The diaphragm pump 500 operates so as to pump out the ink suctioned from the pump inlet port flow path 170 located on the upstream side of the diaphragm pump 500 to the pump outlet port flow path 180 located on the downstream side of the diaphragm pump 500. Accordingly, the ink supplied to the first pressure control chamber 122 is discharged, by driving the diaphragm pump 500, to the supply flow path 130 and the bypass flow path 160, together with the ink sent from the pump outlet port flow path 180.

In the present embodiment, a piezoelectric diaphragm pump having a piezoelectric element attached to the diaphragm as a drive source is used as a diaphragm pump that can send liquid, as will be described in detail below. The piezoelectric diaphragm pump is a pump that sends liquid by varying the inner volume of a pump chamber by inputting a drive voltage to a piezoelectric element to operate two check valves alternately by the pressure variation. The drive voltage is supplied by a pump drive circuit 213 to the diaphragm pump 500. The ink discharged to the supply flow path 130 is discharged to the pressure chamber 12 from the ink supply port of the discharge unit 300 via the common supply path 18, and a part of the ink is discharged from a discharge port 13 by the driving (heating) of an energy generation element 15. The residual ink having not been used for the discharge flows in the pressure chamber 12, passes through the common collection path 19, and then is discharged to the collection path 140 connected to the discharge unit 300. The ink discharged to the collection path 140 is discharged to the second pressure control chamber 152 in the second pressure adjustment unit 150. In contrast, the ink discharged from the first pressure control chamber 122 to the bypass flow path 160 is discharged to the second bubble chamber 151, passes through the communication port 191B, and then is discharged to the second pressure control chamber 152. The ink discharged to the second pressure control chamber 152 via the bypass flow path 160, and the ink collected from the collection path 140 are suctioned into the diaphragm pump 500 via the pump inlet port flow path 170 by the driving of the diaphragm pump 500. The ink suctioned in the diaphragm pump 500 is then sent to the pump outlet port flow path 180, and discharged to the first pressure control chamber 122 again. Hereinafter, the ink discharged from the first pressure control chamber 122 to the second pressure control chamber 152 via the supply flow path 130 and the discharge unit 300, and the ink discharged to the second pressure control chamber 152 via the bypass flow path 160 are discharged to the diaphragm pump 500. The ink is then sent from the diaphragm pump 500 to the first pressure control chamber 122. In this way, the ink circulation is performed in the circulation route.

The flow path connecting the diaphragm pump 500 and the discharge unit 300 to supply the liquid to the discharge unit 300 is referred to as the upstream flow path 101. Specifically, the upstream flow path 101 includes the pump outlet port flow path 180, the first pressure control chamber 122, and the supply flow path 130.

The flow path connecting the diaphragm pump 500 and the discharge unit 300 to mainly collect the liquid from the discharge unit 300 is also referred to as a downstream flow path 102. In other words, the downstream flow path 102 includes the pump inlet port flow path 170, the second pressure control chamber 152, and the collection path 140.

In other words, the diaphragm pump 500 is a pump for sending the liquid in the downstream flow path 102 to the upstream flow path 101 not via the discharge unit 300.

As described above, in the present embodiment, the diaphragm pump 500 can circulate the liquid along the circulation route formed in the liquid discharge head 1. Accordingly, it is possible to suppress the thickening of the ink and the accumulation of the ink precipitation components of color materials in the discharge unit 300, and thus it is possible to maintain the ink fluidity in the discharge unit 300, and the discharge characteristics of the ink at the discharge port 13 in good condition.

Since the circulation route in the present embodiment has a configuration completed within the liquid discharge head 1, the length of the circulation route can also be significantly reduced, compared with a case where the ink circulation is performed between the ink tank 2 provided outside the liquid discharge head 1 and the liquid discharge head 1. For this reason, it is possible to perform the ink circulation by using a small size circulation pump.

The connection flow path between the liquid discharge head 1 and the ink tank 2 also has only a flow path for supplying ink. In other words, the connection flow path does not need a flow path for collecting ink from the liquid discharge head 1 to the ink tank 2. Thus, only a tube for supplying ink needs to be provided to connect the ink tank 2 and the liquid discharge head 1, and an ink collection tube does not need to be provided. Thus, the internal configuration of the liquid discharge apparatus 50 can be made simple with the number of tubes reduced, and thus it is possible to achieve downsizing of the entire apparatus. Further, reducing the number of tubes can reduce ink pressure fluctuations caused by the swinging of the tubes along with the main scanning of the liquid discharge head 1. Further, the swinging of tubes along with the main scanning of the liquid discharge head 1 becomes the driving load on the carriage motor 403 for driving the carriage 53. Thus, the reduction of the number of tubes reduces the driving load on the carriage motor 403, making it possible to simplify the main scanning mechanism including the carriage motor 403. Since the ink does not need to be collected from the liquid discharge head 1 to the ink tank 2, it is also possible to achieve downsizing of the external pump 21. As described above, the present embodiment makes it possible to downsize the liquid discharge apparatus 50 and reduce the cost.

### <Driving Mechanism of Diaphragm Pump>

FIG. 6 is a diagram schematically illustrating a driving mechanism of the diaphragm pump 500. A drive signal is transmitted to a carriage substrate 220 from the CPU 400 mounted on a main substrate 230 included in the liquid discharge apparatus 50 via a flat flexible cable (FFC). A control signal of the pump drive circuit 213 and a reference voltage are transmitted from the carriage substrate 220 to the head electric substrate 210 via an electrical connection portion 212 by the contact connection. The pump drive circuit 213 is mounted on the head electric substrate 210. The pump drive signal output from the pump drive circuit 213 is output to the diaphragm pump 500 via a harness wiring 211 to drive the diaphragm pump 500, and the liquid is circulated. The pump drive circuit 213 can also be arranged on other portions such as the carriage substrate 220 and the main substrate 230.

### <Diaphragm Pump>

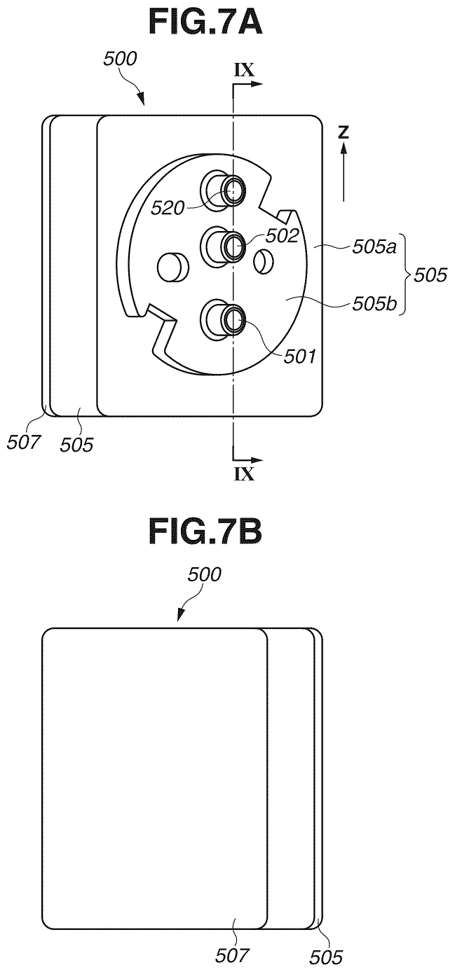

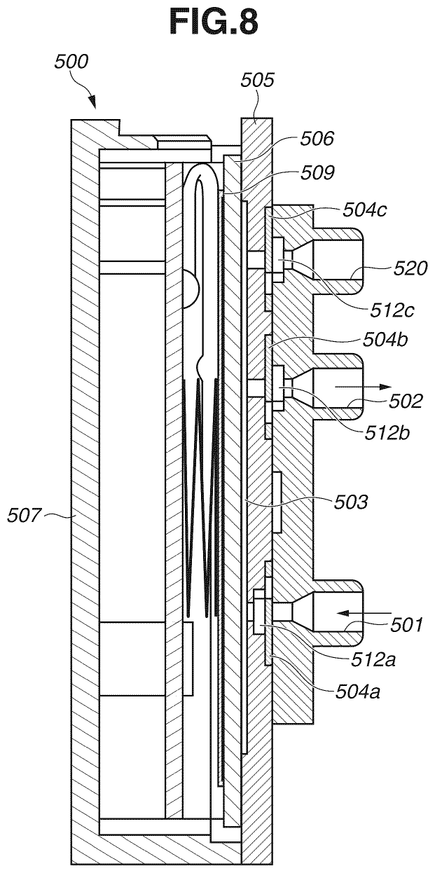

Next, a configuration of the diaphragm pump 500 included in the above-described liquid discharge head 1 will be described in detail with reference to FIGS. 7A, 7B, and 8.

FIGS. 7A and 7B are perspective diagrams each illustrating an external appearance of the diaphragm pump 500. FIG. 7A is the perspective diagram illustrating an external appearance of a front side of the diaphragm pump 500, and FIG. 7B is the perspective diagram illustrating an external appearance of a back side of the diaphragm pump 500. An outer envelope of the diaphragm pump 500 includes a pump housing 505 and a cover 507 fixed to the pump housing 505. The pump housing 505 includes a housing body 505a and a flow path connection member 505b bonded and fixed to the outer surface of the housing body 505a. In the present embodiment, each of the housing body 505a and the flow path connection member 505b is provided with through-holes communicating with each other at three different positions.

The through-hole provided at a first position is a suction hole 501 for suctioning the liquid in the downstream flow path 102 into a pump chamber 503 described below. The through-hole provided at a second position is a discharge hole 502 for discharging the liquid in the pump chamber 503 to an upper flow path. As will be described in detail below, in the present disclosure, a through-hole different from the suction hole 501 and the discharge hole 502 is also provided at a third position. The through-hole is an air bubble discharge hole 520 for discharging air bubbles in the pump chamber 503 by reducing the pressure.

The suction hole 501 is connected to the pump inlet port flow path 170 that is connected to the second pressure control chamber 152, and the discharge hole 502 is connected to the pump outlet port flow path 180 that is connected to the first pressure control chamber 122. When ink is circulated, the ink supplied from the suction hole 501 passes through the below-described pump chamber 503 (see FIG. 8), and is discharged through the discharge hole 502.

FIG. 8 is a cross-section diagram illustrating the diaphragm pump 500 cut along an IX-IX line illustrated in FIG. 7A.

A diaphragm 506 is joined to the inner surface of the pump housing 505, and the pump chamber 503 functioning as a pump is formed between the diaphragm 506 and a recessed portion formed in the inner surface of the pump housing 505. The pump chamber 503 communicates with the suction hole 501 and the discharge hole 502 formed in the pump housing 505. At a middle portion of the suction hole 501, a first check valve 504a for opening and closing the suction hole 501 is provided, and at a middle portion of the discharge hole 502, a second check valve 504b for opening and closing the discharge hole 502 is provided. More specifically, the first check valve 504a is arranged to be movable to the left in FIG. 8 in a space 512a a part of which is formed at the middle portion of the suction hole 501. The second check valve 504b is also arranged to be movable to the right in FIG. 8 in a space 512b a part of which is formed at the middle portion of the discharge hole 502.

A piezoelectric member 509 deformable by applying a voltage is joined to the diaphragm 506. When the piezoelectric member 509 deforms, the diaphragm 506 deforms along with the deformation of the piezoelectric member 509. In a case where the diaphragm 506 deforms in a concave form with respect to the pump chamber 503, the inner volume of the pump chamber 503 increases to reduce the pressure in the pump chamber 503. At this time, the first check valve 504a separates from the opening of the suction hole 501 in the space 512a (i.e., moves left in FIG. 8). The suction hole 501 becomes an open state where ink is dischargeable therethrough by the first check valve 504a separating from the opening of the suction hole 501 in the space 512a. At this time, the second check valve 504b contacts closely to a peripheral wall surface of the opening of the pump housing 505 when the pressure in the pump chamber 503 is reduced, and is brought into a closed state where the ink discharge through the discharge hole 502 is blocked.

In a case where the diaphragm 506 deforms in a convex form with respect to the pump chamber 503, the inner volume of the pump chamber 503 decreases to increase the pressure in the pump chamber 503. At this time, the first check valve 504a closely contacts the peripheral wall surface of the opening of the suction hole 501. As a result, the suction hole 501 becomes a closed state where the ink flow is blocked. In contrast, at this time, the second check valve 504b separates from the opening of the pump housing 505 to move toward the space 512b side (i.e., moves to the right in FIG. 8), and is brought into a closed state where the ink is dischargeable through the discharge hole 502.

Each of the materials of the first check valve 504a and the second check valve 504b only needs to be a material deformable in response to the pressure in the pump chamber 503, and the first check valve 504a and the second check valve 504b can be made of, for example, an elastic member such as an Ethylene Propylene Diene Monomer (EPDM) member and an elastomer member, and a film or a thin sheet such as a polypropylene film. However, the materials are not limited thereto.

As described above, the pump chamber 503 is formed by joining the pump housing 505 and the diaphragm 506. The pressure in the pump chamber 503 therefore varies by the deformation of the diaphragm 506. For example, when the diaphragm 506 displaces toward the pump housing 505 (deforms in the right side in FIG. 8) to reduce the inner volume of the pump chamber 503, the pressure in the pump chamber 503 increases. With this pressure increase, the second check valve 504b arranged to face the discharge hole 502 becomes an open state to discharge the ink in the pump chamber 503. At this time, since the first check valve 504a arranged to face the suction hole 501 is in close contact with a peripheral wall surface of the suction hole 501, a reverse flow from the pump chamber 503 to the suction hole 501 can be prevented. In an opposite manner thereto, when the diaphragm 506 deforms to a direction to increase the inner volume of the pump chamber 503, the pressure in the pump chamber 503 decreases. In this way, the first check valve 504a arranged to face the suction hole 501 becomes an open state, and ink is supplied into the pump chamber 503. At this time, the second check valve 504b arranged in the discharge hole 502 is in close contact with a peripheral wall surface of the opening formed in the pump housing 505 to close the opening. Accordingly, the reverse flow of the ink from the discharge hole 502 into the pump chamber 503 is prevented. In this way, the diaphragm pump 500 suctions and discharges ink by deforming the diaphragm 506 to vary the pressure in the pump chamber 503.

### <Air Bubble Discharge Configuration of Diaphragm Pump>

As described above, in the case where air bubbles enter the pump chamber 503, even when the diaphragm 506 displaces, the pressure variation in the pump chamber 503 becomes small due to the air bubbles repeatedly expanding and contracting, to reduce the liquid sending efficiency.

In response, in the embodiment of the present disclosure, each of the housing body 505a and the flow path connection member 505b is provided with the air bubble discharge hole 520 as a through-hole different from the suction hole 501 and the discharge hole 502. At a middle portion of the air bubble discharge hole 520, a third check valve 504c for opening and closing the air bubble discharge hole 520 is provided. More specifically, the third check valve 504c is arranged so as to be movable to the right in FIG. 8 in a space 512c a part of which is formed at the middle portion of the air bubble discharge hole 520.

The air bubble discharge hole 520 is connected with an air bubble discharge flow path 530 formed in the liquid discharge head 1, and the air bubble discharge flow path 530 is also connected with a suction flow path 540 connected with the main body. A suction pump 550 (pressure reduction unit) of the main body side is connected to an opposite side of an end portion of the suction flow path 540 connected with the air bubble discharge flow path 530.

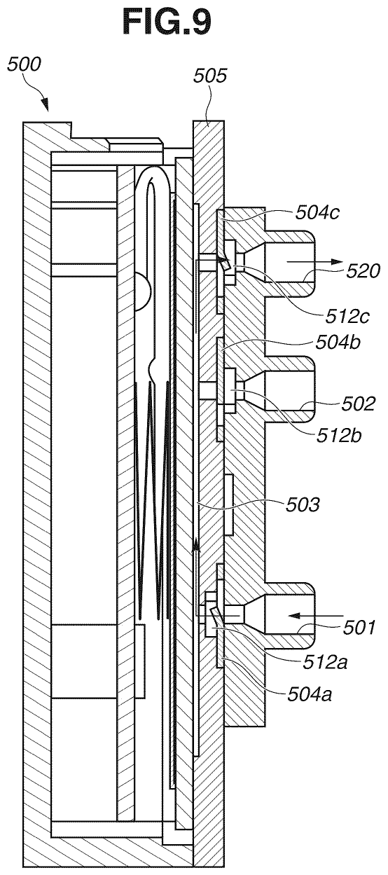

Next, an air flow at an air bubble discharge time will be described. FIG. 9 is a diagram illustrating the air flow at the air bubble discharge time. First, similar to the operation at the normal time, ink is supplied from the ink tank 2 into the liquid discharge head 1 by the external pump 21. At the same time, the pressure in the air bubble discharge hole 520 is reduced by the suction pump 550 in the main body via the suction flow path 540 and the air bubble discharge flow path 530. At this time, since the pressure of a side of the third check valve 504c opposite to the diaphragm pump 500 (right side in FIG. 9) is reduced, the third check valve 504c moves toward the air bubble discharge flow path 530 (right side in FIG. 9) in the space 512c, and the air bubble discharge flow path 530 and the pump chamber 503 communicate with each other via the air bubble discharge hole 520. Since the pressure of the air bubble discharge hole 520 is reduced by the suction pump 550, the air bubbles present in the pump chamber 503 are discharged to the air bubble discharge flow path 530 through the air bubble discharge hole 520.

As described above, since the diaphragm pump 500 according to the present embodiment includes the air bubble discharge hole 520 for discharging the air bubbles having entered the pump chamber 503, the air bubbles having entered the pump chamber 503 can be discharged without driving the diaphragm pump 500 by a high voltage.

Further, when the air bubbles in the pump chamber 503 are discharged to the air bubble discharge flow path 530, since the pressure in the pump chamber 503 is reduced, the first check valve 504a of the suction hole 501 moves toward the pump chamber 503 in the space 512a to open, and the pump inlet port flow path 170 and the inside of the pump chamber 503 communicate with each other. Thus, the pressure in the pump inlet port flow path 170 is also reduced. In addition, at this time, since the pressure in the pump chamber 503 is in a reduced state, the second check valve 504b is in a closed state. As described above, since the pump inlet port flow path 170 is connected with the second pressure control chamber 152, the pressure in the second pressure control chamber 152 is also reduced to open the valve 190B, and the first pressure adjustment unit 120 and the ink tank 2 are connected via the bypass flow path 160. Thus, by continuing the suctioning by the suction pump 550, the ink from the ink tank 2 is suctioned into the pump chamber 503 with time. Even after discharging the air bubbles in the pump chamber 503, by continuing the driving of the suction pump 550, the air bubbles in the downstream flow path 102 and the upstream flow path 101 can also be discharged outside the circulation flow path via the air bubble discharge hole 520.

### Modification Example of First Embodiment

In the bubble discharging by the diaphragm pump 500, by providing a mechanism for detecting ink between the air bubble discharge hole 520 and the suction pump 550, it is possible to stop the suction operation when the ink is detected. This makes it possible to prevent the suction pump 550 from suctioning ink. Alternatively, a similar effect can be obtained by using a method of estimating a time period until ink reaches inside the pump chamber 503, and continuing the suctioning during the time period.

Even when the ink detection mechanism or the ink suctioning time period setting is used, there may also be a case where ink is suctioned from the diaphragm pump 500 toward the suction pump 550 in a noticeable amount. Thus, it is desirable that the liquid discharge apparatus 50 is provided with a reservoir portion (not illustrated) for reserving the ink suctioned by the suction pump 550 at a middle of the air bubble discharge flow path 530 or the suction flow path 540, and an ink returning mechanism for supplying ink reserved in the reservoir portion again to the ink tank 2 or the discharge unit 300.

In the present embodiment, the suction pump 550 (pressure reduction unit) is provided outside the liquid discharge head 1 in the liquid discharge apparatus 50, but the suction pump 550 can also be provided inside the liquid discharge head 1. In this case, the air bubble discharge flow path 530, an air bubble suction flow path, and a collection reservoir portion are also provided in the liquid discharge head 1. In a case where the suction pump 550 is provided in the liquid discharge apparatus 50, the size of the liquid discharge head 1 can be reduced. In contrast, in a case where the suction pump 550 is provided in the liquid discharge head 1, when the collection reservoir portion is also mounted on the liquid discharge head 1, it becomes easy to supply the ink in the reservoir portion to the discharge unit 300 by the ink returning mechanism.

In addition, the opening pressure of the third check valve 504c is desirably larger than the opening pressure of the second check valve 504b arranged in the discharge hole 502. In this way, at the ink circulation time (diaphragm pump driving time), when the diaphragm 506 displaces toward the pump housing 505 (right side in FIG. 9) and the pressure in the pump chamber 503 increases, the second check valve 504b opens before the third check valve 504c. When the second check valve 504b opens first, since the pressure in the pump chamber 503 decreases, the risk of opening the third check valve 504c is reduced, and at the diaphragm pump driving time, the risk of the ink discharging via the air bubble discharge hole 520 can also be reduced.

To obtain such an effect, the third check valve 504c in the air bubble discharge hole 520 may be made less deformable using an urging member such as a spring, without making the materials and stiffness of the third check valve 504c and the second check valve 504 b different. The opening pressure of the third check valve 504 c is desirably 10 kPa (kilopascal) or more because it is desirable that the third check valve 504c opens only when the air bubbles are discharged and does not open when the diaphragm pump 500 is driven.

To increase the discharge efficiency of the air bubbles from the pump chamber 503, when the liquid discharge head 1 is used, the air bubble discharge hole 520 can be located vertically above the suction hole 501 and the discharge hole 502. Since buoyancy acts on the air bubbles in the pump chamber 503, the air bubbles in the pump chamber 503 are trapped near the air bubble discharge hole 520 to easily discharge the air bubbles.

Similarly, in a use state of the liquid discharge head 1, the discharge hole 502 can be located vertically above the suction hole 501. The air bubbles in the pump chamber 503 can also be easily discharged through the discharge hole 502, when the discharge hole 502 is located vertically above the suction hole 501.

In the present embodiment, the air bubble discharge hole 520 is formed on the same surface of the suction hole 501 and the discharge hole 502 of the diaphragm pump 500, but the air bubble discharge hole 520 can also be arranged in a surface different from that of the suction hole 501 and the discharge hole 502, as long as the air bubble discharge hole 520 communicates with the pump chamber 503.

Even in a case where the circulation pump is mounted on the liquid discharge head 1, when the circulation pump is the diaphragm pump 500 according to the present embodiment, it is possible to reduce the influence on the size of the liquid discharge head 1, and to circulate the liquid. Since the diaphragm pump 500 according to the present embodiment has the air bubble discharge hole 520 for discharging the air bubbles having entered the pump chamber 503, it is also possible to discharge the air bubbles having entered the pump chamber 503 without driving the diaphragm pump 500 by a high voltage.

In addition, in the present embodiment, the diaphragm pump 500 is mounted on the liquid discharge head 1 as a premise, but the diaphragm pump 500 can also be mounted on the liquid discharge apparatus 50.

### Second Embodiment

Next, a liquid discharge head 1 and a liquid discharge apparatus 50 according to a second embodiment will be described. The second embodiment is mainly different from the first embodiment in that the air bubble discharge flow path 530 is connected to the pump outlet port flow path 180 without including the air bubble discharge hole 520 for discharging air bubbles from the pump chamber 503 in the diaphragm pump 500. In the following descriptions, portions different from those of the first embodiment will mainly be described, and the descriptions of portions similar to those of the first embodiment will be omitted.

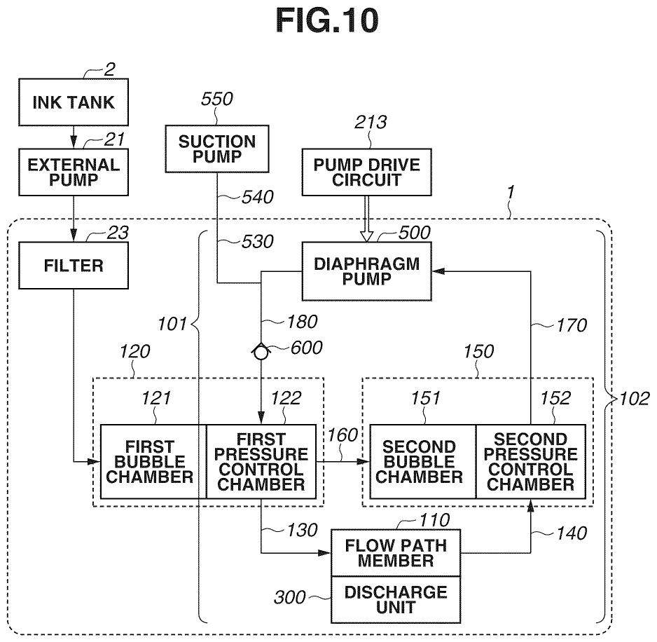

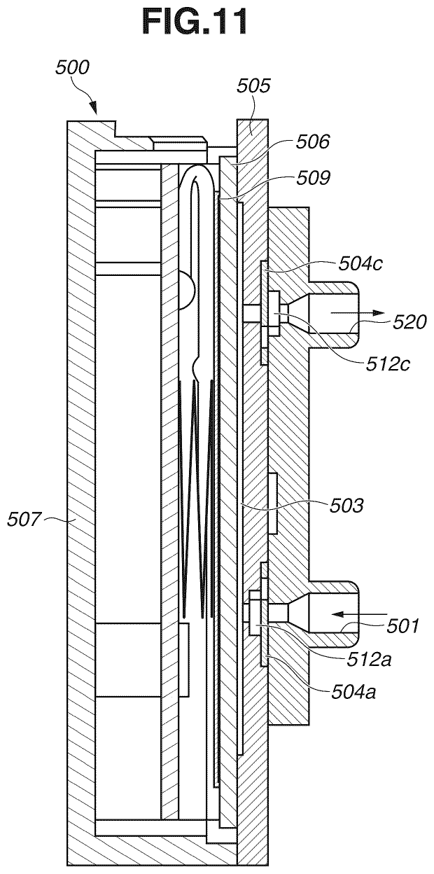

FIG. 10 is a block diagram schematically illustrating a circulation route according to the second embodiment. FIG. 11 is a cross-section diagram schematically illustrating the diaphragm pump 500 according to the second embodiment. As illustrated in FIG. 11, the suction hole 501 and the discharge hole 502 are formed in the diaphragm pump 500 according to the present embodiment, similar to the first embodiment, but the air bubble discharge hole 520 is not formed. Instead, as illustrated in FIG. 10, the air bubble discharge flow path 530 is connected to the pump outlet port flow path 180 in the upstream flow path 101, and, similar to the first embodiment, the air bubble discharge flow path 530 is connected with the suction pump 550 (pressure reduction unit) via the suction flow path 540.

When the suction pump 550 is driven, the pressure in each of the suction flow path 540, the air bubble discharge flow path 530, and the pump outlet port flow path 180 is reduced, and the check valve 504b blocking the discharge hole 502 opens.

Then, since the pressure in the pump chamber 503 is reduced, the air bubbles in the pump chamber 503 are suctioned by the suction pump 550 via the discharge hole 502, the pump outlet port flow path 180, the air bubble discharge flow path 530, and the suction flow path 540. In this way, the air bubbles in the pump chamber 503 can be discharged. Since the air bubbles in the pump chamber 503 are discharged by the suction pump 550 located outside the diaphragm pump 500, the air bubbles having entered the pump chamber 503 can be discharged without driving the diaphragm pump 500 by a high voltage.

In the present embodiment, a regulation valve 600 for preventing the liquid from being discharged to the air bubble discharge flow path 530 from the discharge unit 300 not via the diaphragm pump 500 is provided in the upstream flow path 101. In other words, the regulation valve 600 is provided between the diaphragm pump 500 and the first pressure control chamber 122 in the upstream flow path 101. In addition, the configuration of the regulation valve 600 is not limited as long as the flow of the liquid from the diaphragm pump 500 to the second pressure control chamber 152 is allowed, and the flow of the liquid opposite thereto is prevented.

Also, according to the second embodiment, it is possible to discharge the air bubbles having entered the pump chamber 503 without complicating the apparatus and without driving the diaphragm pump 500 by a high voltage.

According to the present disclosure, a liquid discharge head capable of discharging air bubbles having entered a pump chamber without complicating the apparatus and driving a diaphragm pump by a high voltage, and a liquid discharge apparatus employing the liquid discharge head can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-193514, filed Nov. 5, 2024, which is hereby incorporated by reference herein in its entirety.

What is claimed is:

1. A liquid discharge head comprising:
a discharge unit configured to discharge liquid;
an upstream flow path configured to supply liquid to the discharge unit;
a downstream flow path configured to collect liquid from the discharge unit; and
a diaphragm pump configured to send liquid in the downstream flow path to the upstream flow path not via the discharge unit,
wherein the diaphragm pump includes
a pump chamber configured to function as a pump,
a suction hole configured to suction the liquid in the downstream flow path into the pump chamber, and
a discharge hole configured to discharge the liquid in the pump chamber to the upstream flow path,
wherein the pump chamber is formed with an air bubble discharge hole different from the suction hole and the discharge hole, and
wherein air bubbles in the pump chamber are discharged outside through the air bubble discharge hole by reducing a pressure in the air bubble discharge hole.

2. The liquid discharge head according to claim 1,
wherein the diaphragm pump includes,
a first check valve configured to open and close the suction hole,
a second check valve configured to open and close the discharge hole, and
a third check valve configured to open and close the air bubble discharge hole.

3. The liquid discharge head according to claim 2,
wherein the diaphragm pump includes,
a piezoelectric member configured to deform by applying a voltage,
a diaphragm configured to displace along with a deformation of the piezoelectric member, and
wherein the pump chamber functions as a pump by varying an inner volume of the pump chamber by a displacement of the diaphragm.

4. The liquid discharge head according to claim 2, wherein an opening pressure of the third check valve is larger than an opening pressure of the second check valve.

5. The liquid discharge head according to claim 4, wherein the opening pressure of the third check valve is 10 kPa or more.

6. The liquid discharge head according to claim 2, wherein the second check valve is in a closed state when the third check valve is in an open state.

7. The liquid discharge head according to claim 1, wherein, in a state where the liquid discharge head is in a use state, the air bubble discharge hole is located vertically above the discharge hole.

8. The liquid discharge head according to claim 1, wherein, in a state where the liquid discharge head is in a use state, the air bubble discharge hole is located vertically above the suction hole.

9. The liquid discharge head according to claim 8, wherein, in a state where the liquid discharge head is in the use state, the air bubble discharge hole is located vertically above the discharge hole.

10. The liquid discharge head according to claim 1, further comprising a pressure reduction unit configured to reduce a pressure in the air bubble discharge hole.

11. The liquid discharge head according to claim 10, further comprising an air bubble discharge flow path configured to connect the air bubble discharge hole and the pressure reduction unit,
wherein the air bubble discharge flow path is provided with a reservoir portion configured to reserve liquid suctioned by the pressure reduction unit.

12. The liquid discharge head according to claim 10, wherein the pressure reduction unit is different from the diaphragm pump.

13. A liquid discharge apparatus comprising:
a liquid discharge head including,
a discharge unit configured to discharge liquid,
an upstream flow path configured to supply liquid to the discharge unit,
a downstream flow path configured to collect liquid from the discharge unit, and
a diaphragm pump configured to send liquid in the downstream flow path to the upstream flow path not via the discharge unit,
wherein the diaphragm pump includes,
a pump chamber configured to function as a pump,
a suction hole configured to suction the liquid in the downstream flow path into the pump chamber, and
a discharge hole configured to discharge the liquid in the pump chamber to the upstream flow path,
wherein the pump chamber is formed with an air bubble discharge hole different from the suction hole and the discharge hole, and
wherein air bubbles in the pump chamber are discharged outside through the air bubble discharge hole by reducing a pressure in the air bubble discharge hole, and
a pressure reduction unit provided outside the liquid discharge head to reduce the pressure in the air bubble discharge hole.

14. The liquid discharge apparatus according to claim 13, further comprising an air bubble discharge flow path configured to connect the air bubble discharge hole and the pressure reduction unit,
wherein the air bubble discharge flow path is provided with a reservoir portion configured to reserve liquid suctioned by the pressure reduction unit.

15. The liquid discharge apparatus according to claim 14, wherein the pressure reduction unit is different from the diaphragm pump.

16. A liquid discharge head comprising:
a discharge unit configured to discharge liquid;
an upstream flow path configured to supply liquid to the discharge unit;
a downstream flow path configured to collect liquid from the discharge unit; and
a diaphragm pump including a pump chamber configured to send liquid in the downstream flow path to the upstream flow path not via the discharge unit,
wherein an air bubble discharge flow path is connected to the upstream flow path,
wherein air bubbles in the pump chamber are discharged outside through the air bubble discharge flow path via the upstream flow path by causing a pressure in the air bubble discharge flow path to be lower than a pressure in the pump chamber, and
wherein the upstream flow path is provided with a regulation valve configured to prevent the liquid from being suctioned to the air bubble discharge flow path from the discharge unit, not via the diaphragm pump.

17. The liquid discharge head according to claim 16, further comprising a pressure reduction unit configured to reduce a pressure in the air bubble discharge flow path.

18. The liquid discharge head according to claim 16,
wherein the upstream flow path is provided with a pressure control chamber,
wherein the pressure control chamber adjusts a pressure in a flow path between the pressure control chamber and the discharge unit in the upstream flow path, and
wherein the regulation valve is provided between the diaphragm pump and the pressure control chamber in the upstream flow path.

19. The liquid discharge head according to claim 18, wherein the air bubble discharge flow path is connected between the diaphragm pump and the regulation valve in the upstream flow path.
